(19) United States
(12) Patent Application Publication
(10) Pub. No.: US 2022/0246068 A1
(43) Pub. Date: Aug. 4, 2022

(54) DISPLAY CLIP MOUNTING MEMBER

(71) Applicant: JOEP PATERNOSTRE, WAYNESBORO, VA (US)

(72) Inventor: JOEP PATERNOSTRE, WAYNESBORO, VA (US)

(21) Appl. No.: 17/649,270

(22) Filed: Jan. 28, 2022

Related U.S. Application Data
(60) Provisional application No. 63/143,777, filed on Jan. 29, 2021.

(51) Int. Cl. G09F 7/18; G09F 13/22; A01G 9/02

(52) U.S. Cl. CPC G09F 7/18; G09F 2007/1856; A01G 9/022; G09F 13/22

(57) ABSTRACT

A mounting member in the nature of a display clip including a first body and second body joined at one end, each of the first and second bodies having an inner surface. Use of strategically placed ribs and cavities on one or both of the first body and second bodies facilitate stabilization of the mounting member generally, resistance to unintentional removal, and content displays on a product or container.

This non-provisional patent application claims all benefits under 35 U.S.C. § 119(e) of pending U.S. provisional patent application Ser. No. 63/143,777 filed 29 Jan. 2021, entitled “DISPLAY CLIP MOUNTING MEMBER”, in the United States Patent and Trademark Office, which is incorporated by reference in its entirety herein.

### FIELD OF THE INVENTION

The present disclosure relates generally to a display clip, more specifically, to a display clip mounting member enabling a user to affix accessories to a product or container.

### DESCRIPTION OF THE PRIOR ART AND OBJECTIVES OF THE INVENTION

Manufacturers, distributors, and retailers often require the ability to affix accessories on a product or container. It is often advantageous to affix accessories such as promotional materials, eye-catching displays, pricing, advertisements, messages, art, content, or any combination thereof to a product or container in a distinguishable manner. Accessories may also include such items like sale price tags, store sales, marketing ads, or other specific information necessary to promote the sale of a product, support elements, attention grabbers, and other materials necessary for a particular product to sell effectively.

Typically, displaying accessories on a product or container requires printing or adhering content directly onto a product or container. Current approaches are tedious, inefficient, costly, and do not allow for quick and convenient customization by the user and/or third parties. However, it is important for a user to have flexibility as to when to affix accessories to a product or container at various stages in production, shipping, distribution, and sales. For example, a user may desire to affix accessories to a product before the product is shipped to a retailer or after the product has arrived at a retail location. These requirements are largely dependent on the type of product or container being shipped, stored, and sold as well as the accessories being affixed.

Existing alternatives to printing or adhering accessories directly to a product or container include visual presentation devices that extend conspicuously beyond the product or container to which they are affixed in a way that can prevent a user from stacking multiple products or placing products on shelves that are closely spaced apart. For example, when existing devices are in use with products or containers that are stacked, one or all of the devices and products or containers to which the devices are attached sustain damage due to the vulnerability of the device, product packaging, and product weight. Attempts to resolve issues arising when shipping products using existing visual presentation devices require unique packaging efforts that cause increased shipping costs relating to additional packaging material, additional weight, and larger package dimensions. Furthermore, when existing devices are affixed to a product or container, they are easily knocked over or removed completely during packing and display efforts. Having an eye-catching, removable, durable, stackable mounting member that is easily affixed to a product or container would allow a user to quickly exchange accessories and have the flexibility to customize appearance and functionality of a particular product or container.

Previous attempts to address these problems have fallen short. A continuous need in the industry remains to improve a mounting member capable of accommodating these concerns.

It is another objective of the present disclosure to provide a clip device that has a minimally obstructive profile when detachably secured to a product or container during storage, shipment, or use so as to resist unintended removal or damage during the stacking, packaging, shipping, shelving, or displaying of multiple products together.

It is still another objective of the present disclosure to provide a clip device that facilitates flexibility in the type of accessories that can be affixed to a product or container. Accessories can enhance the display and marketability of a product or container, such accessories include promotional materials, sale price tags, or attention grabbers. Accessories may also support and stabilize a product within a container during storage, shipment, and use, such as product support elements.

It is yet another objective of the present disclosure to provide a clip device that provides versatility in the timing of when certain types of accessories are affixed to a product or container. For example, a first accessory, such as a support element, can be affixed to a product or container in the early stages of production to stabilize a product within a container during storage, shipment, and use. After a product has shipped to a retailer, for example, a second accessory, such as a sale price tag, can be affixed to the product or container to enhance the marketing and display of the product or container.

It is a further objective of the present disclosure to provide a clip device that is easily manufactured into different shapes, sizes, colors, and configurations to include branding and product information that increases product awareness and brand name recognition to a product or container.

It is yet a further objective of the present disclosure to provide a method of using a clip device and accessory to support and stabilize a product within a container during storage, shipment, and use, the method comprising grasping the clip device to detachably secure the clip device to a container holding a product, then inserting a first accessory into a portion of the clip device so that the first accessory is retained by the clip device, wherein the first accessory is a product support element, then arranging the first accessory around the product to support and stabilize the product within the container throughout storage, shipment, and use.

It is still a further objective of the present disclosure to provide a method of affixing more than one accessories to a product or container at different stages of storage, shipment, display, sale, and use to enhance the display and marketability of the product or container, the method comprising installing a clip device configured to receive and retain more than one accessory to a product or container, then inserting a first accessory into a first portion of the clip device so that the first accessory is retained by the clip device, then after the product or container has been shipped, for example, to a retail store, for display and sale, inserting a second accessory into a second portion of the clip device so that the first and second accessory are retained by the clip device and affixed to the product or container.

Various other objectives and advantages of the present disclosure will become apparent to those skilled in the art as a more detailed description is set forth below.

### SUMMARY OF THE INVENTION

The aforesaid and other objectives are realized by providing a mounting member, typically affixed to the rim or edge of a product or container that allows a user to easily affix and/or remove various additional accessories to a product or container. The mounting member includes a first body and second body, each having an inner surface. The first body and second body come together at a hinge, which can be semi-rigid, living spring, or separable, typically in a U-shaped fashion, such that the first body inner surface and second body inner surface are capable of being disposed toward each other at a proximal end of the first and second bodies opposite from the hinge. Use of strategically placed ribs and cavities on one or both of the first body and second bodies facilitate stabilization of the mounting member generally, resistance to unintentional removal, and content displays on a product or container.

The mounting member may be configured with minimally obstructive design, so as to be functionally and structurally inconspicuous, or visually neutral, and allow a product or container to be easily stored and shipped with the mounting member secured. The low profile design of the mounting member eliminates the risk of damage and mistaken dislodging of the mounting member and accessory while used in combination with products or containers that are packaged together with other products and containers. Additional features and advantages of the disclosure will be set forth in the description which follows, and in part will be obvious from the description, or may be learned by the practice of the disclosure. The disclosed aspects of the disclosure herein are merely exemplary as the disclosure may be embodied in various forms. Therefore the disclosure is not limited in its application to the specific structural and functional details disclosed and not to the arrangements of the components set forth in the following description or illustrated in the drawings. The disclosure is capable of other embodiments and of being practiced and carried out in other ways. As such, those skilled in the art will appreciate that the conception upon which the distinction of the disclosure is based, may readily be utilized as a basis for designing other structures and methods for carrying out the disclosure.

### BRIEF DESCRIPTION OF THE DRAWINGS

FIG. 1 is a perspective view of a mounting member according to an embodiment of the present disclosure;

FIG. 2 is a perspective exploded view of a mounting member according to an embodiment of the present disclosure;

FIG. 3A is a perspective view of the first body of the mounting member of FIG. 2;

FIG. 3B is a perspective view of the second body of the mounting member of FIG. 2;

FIG. 4 is a right side view of an alternate embodiment of the mounting member of FIG. 1;

FIG. 5A is a top plan view of the mounting member of FIG. 1;

FIG. 5B is a right side view of another alternate embodiment of the mounting member of FIG. 1 as applied to a container;

FIG. 5C is a top plan view of a further alternate embodiment of the mounting member of FIG. 1 having configurations of depressions that are square in shape;

FIG. 5D is a right side view of the mounting member of FIG. 5C as applied to a container;

FIG. 6 is a perspective view of an embodiment of the present disclosure in a typical environment with no accessories;

FIG. 7A is a perspective view of an embodiment of the present disclosure in a typical environment with an accessory affixed to the mounting member outside a container;

FIG. 7B is a perspective view of an embodiment of the present disclosure in a typical environment with an accessory affixed to the mounting member inside a container;

FIG. 7C is a perspective view of an embodiment of the present disclosure in a typical environment with an accessory affixed to the mounting member above a container;

FIG. 8 is a perspective view of an embodiment of the present disclosure in a typical environment with an accessory affixed to the mounting member for stabilizing a product within a container;

FIG. 9 is a perspective view of still a further alternate embodiment of the present disclosure with a compartment for an illumination system;

FIG. 10 is a block diagram of one embodiment of an illumination system used with the present disclosure.

### DETAILED DESCRIPTION OF THE PREFERRED EMBODIMENT AND OPERATION OF THE INVENTION

Various exemplary embodiments of the present disclosure are described below. Use of the term “exemplary” means illustrative or by way of example only, and any reference herein to “the disclosure” is not intended to restrict or limit the disclosure to exact features or step of any one or more of the exemplary embodiments disclosed in the present specification. References to “exemplary embodiment”, “one embodiment”, “an embodiment”, “various embodiments”, and the like may indicate that the embodiment(s) of the disclosure so described may include a particular feature, structure, or characteristic, but not every embodiment necessarily incudes the particular feature, structure, or characteristic. Further, repeated use of the phrase “in one embodiment”, “in an exemplary embodiment”, or “in an alternative embodiment” do not necessarily refer to the same embodiment, although they may.

It is also noted that terms like “preferably”, “commonly”, and “typically” are not utilized herein to limit the scope of the disclosure or to imply that certain features are critical, essential, or even important to the structure or function of the disclosure. Rather, these terms are merely intended to highlight alternative or additional features that may or may not be utilized in a particular embodiment of the present disclosure.

The present disclosure is described more fully hereinafter with reference to the accompanying figures, in which one or more exemplary embodiments of the disclosure are shown. Like numbers used herein refer to like elements throughout. The disclosure may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limited as to the scope of the disclosure, and any and all equivalents thereof. Moreover, many embodiments such as adaptations, variations, modifications, and equivalent arrangements will be implicitly disclosed by the embodiments described herein and fall within the scope of the instant disclosure.

Although specific terms are employed herein, they are used in a generic and descriptive sense only and not for the purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. Where only one item is intended, the terms “one and only one”, “single”, or similar language is used. When used herein to join a list of items, the term “or” denotes at least one of the items but does not exclude a plurality of items of the list.

For exemplary methods or processes of the disclosure, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present disclosure.

Additionally, any references to advantages, benefits, unexpected results, or operability of the present disclosure are not intended as an affirmation that the disclosure has previously been reduced to practice or that any testing has been performed. Likewise, unless stated otherwise, use of verbs in the past tense (present perfect or preterit) is not intended to indicate or imply that the disclosure has previously been reduced to practice or that any testing has been performed.

For a better understanding of the disclosure and its operation, turning now to the drawings, the present disclosure is directed to a mounting member 100 in the nature of a display clip defining a minimally obstructive profile. The mounting member is configured (i.e. sized, shaped, and otherwise capable) of being removably secured to a product or container while resisting unintentional removal, and allowing multiple products or containers used in combination with the mounting member to be packaged together and stacked. The mounting member includes a first body and a second body that are hinged together such that they are capable of being disposed toward each other at proximal ends opposite from the hinge. Alternatively, the bodies may be hinged such that they are capable of being extended apart from each other at the hinge. The mounting member can be manufactured from a single-piece construction or, alternatively, a multi-piece construction. The size, shape, and curvature of each body of the mounting member depends on the product or container to which the mounting member will be secured. The first body and second body may be manufactured from a resilient material, including, but not limited to: metal; plastic; rubber; acrylic; polypropylene; or cellulose material such as paper, cardboard, or wood. Those in the art will understand that any material, now known or hereafter developed, may be used in forming the display clip mounting member described herein. The mounting member may be manufactured in different sizes, shapes, colors, and configurations of colors suitable for purposes described herein.

The instant mounting member is easily manufactured and designed to be minimally obstructive during packaging, storing, and shipping. Other aspects of the present disclosure include facilitating flexibility in the type, location, and timing of when certain accessories are affixed to a product or container, significantly increasing the product awareness and brand name recognition of a product, and aiding in the stabilization of certain products within a container. These features, along with others will be inherent after reading this disclosure.

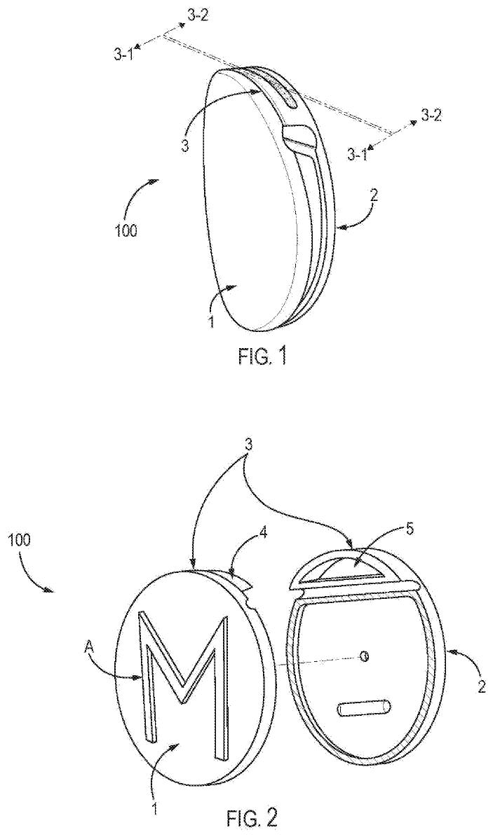

FIG. 1 is a perspective view of one embodiment of the mounting member 100 of the present disclosure comprising a first body 1 and a second body 2 connected at a hinge 3. In this embodiment, the first body 1 and the second body 2 are constructed as two separate pieces that are hinged along the perspective lines of 3-1 and 3-2, such that the first body 1 and second body 2 are disposed towards touching each other at their proximal ends opposite from the hinge 3.

FIG. 2 illustrates an exploded view of one embodiment of the mounting member 100 of the present disclosure showing the hinge 3 comprising a male adaptor 4 optionally located on first body 1 and a female adaptor 5 optionally located on second body 2. The male adaptor 4 is configured to nestle into the female adaptor 5. One or more tactile elements A may be positioned on first body 1 to assist with gripping of the mounting member 100 and for advertising. In another embodiment, the first body 1 and the second body 2 are constructed of a single piece of material that is hinged such that the first body 1 and the second body 2 are disposed toward touching each other at their proximal ends opposite from the hinge 3. In a preferred embodiment, the male adaptor 4 is located on the first body 1 and the female adaptor 5 is located on the second body 2 to enhance the aesthetic of the mounting member 100.

The hinge 3, as used with the present disclosure, can be flexible or rigid in the nature of a biasing member. Examples of a hinge include, without limitation, a concealed hinge, spring-loaded hinge, living hinge of flexible, resilient material, composite hinge, and any other hinge capable of withstanding stress. It is to be understood that hinges disclosed herein are merely exemplary and various types of hinges that exist or may exist in the future are capable of being used without departing from the function and purpose of such a hinge as described in this disclosure.

In the preferred embodiment and in association with the method of manufacturing one or more embodiments of mounting member 100, tactile elements A are embossed, but it should be understood that tactile elements can be, for example, embedded, molded, engraved, laser engraved, stamped, mixed media, and any combination thereof. Tactile elements A may be separate elements affixed to the present disclosure through the use of an adhesive. Tactile elements A may be located anywhere on the mounting member 100 and act to increase grip friction during the installation and removal of the mounting member 100. Tactile elements A may be used to display any type of visual presentation such as the display of an image, logo, text, trade name, emblem, and any combination thereof.

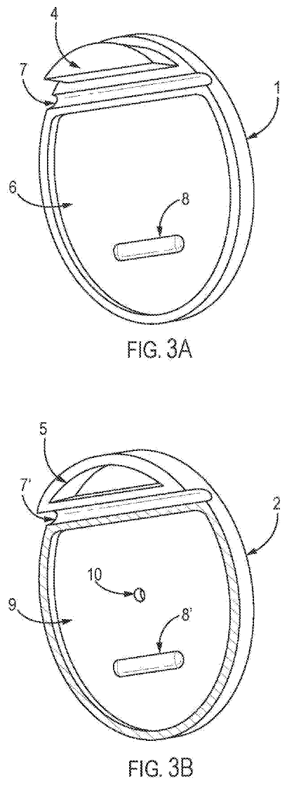

FIG. 3A is an exploded perspective view of the first body 1 of FIG. 1 along the perspective of 3-1 from FIG. 1 showing the male adaptor 4, a first body inner surface 6, a depression 7, and a rib 8. The depression 7 is a hollow within the first body inner surface 6 that extends across the length of the first body 1 just below the male adaptor 4. The rib 8 is a protuberance from the first body inner surface 6 of first body 1 to facilitate gripping. In another embodiment, depression 7 can be located anywhere on the first body 1. As would be understood rib 8 could likewise be located anywhere on the first body 1, whether spaced from or proximate depression 7, preferably positioned below depression 7.

FIG. 3B is an exploded perspective view of the second body 2 of FIG. 1 along the perspective of line 3-2 of FIG. 1 showing the second body 2, the female adaptor 5, a second body inner surface 9, a depression 7′, a rib 8′, and an aperture 10. The depression 7′ is a hollow within the second body inner surface 9 that extends across the length of the second body 2 just below the female adaptor 5. The rib 8′ is a protuberance from the second body inner surface 9 of second body 2 to facilitate gripping. The aperture 10 extends through the second body 2 and can facilitate use of accessories with the mounting member. In another embodiment, one or more apertures 10 may optionally be located in the first body 1, the second body 2, or any combination thereof. At any given time, any number of apertures 10 may be engaged with accessories. In another embodiment, depression 7′ can be located anywhere on the second body 2. As would be understood rib 8′ could likewise be located anywhere on the second body 2, whether spaced from or proximate depression 7′, preferably positioned below depression 7′.

In a preferred embodiment, at least one rib 8 or 8′ is located on each of the first body inner surface 6 of the first body 1 near its center and on the second body inner surface 9 of the second body 2 near its center. In another embodiment, one or more ribs 8, 8′ may optionally be located on the first body inner surface 6 of the first body 1 and the second body inner surface 9 of the second body 2, spaced apart in opposing relation, one pair of ribs 8, 8′ near the center in a lower position, and one pair of ribs 8, 8′ proximate depressions 7, 7′ in an upper position. Since ribs 8, 8′ are typically tightly in contact with the surface of the container, they can be used to clamp and retain accessories. Ribs 8, 8′ placement in a preferred embodiment facilitates a more secure and stable application of an accessory to the mounting member 100 and application of the mounting member 100 to the container or product by causing increased resistance against the forces that cause the first body 1 and the second body 2 to be disposed toward each other. To further increase the ability to clamp and retain, accessories may have a punch out of the same size and shape of ribs 8, 8′.

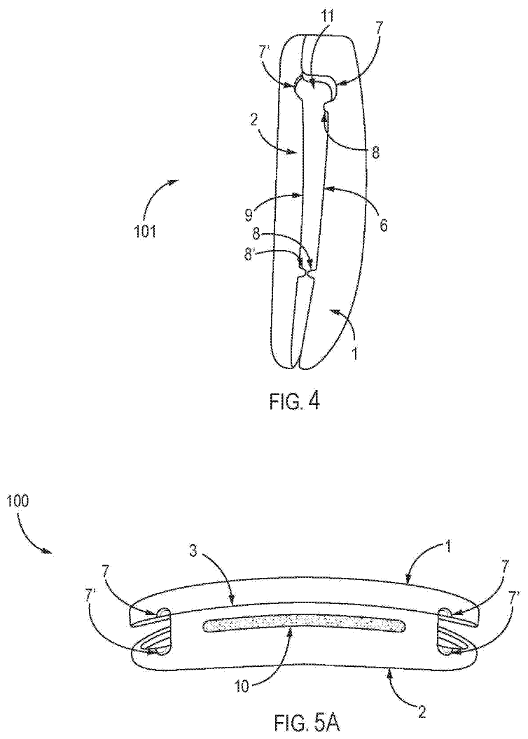

FIG. 4 is a right side view of an alternate embodiment 101 of the mounting member 100 of FIG. 1 having ribs 8, 8′. A single rib 8′ is located on the second body inner surface 9 of the second body 2 and a pair of ribs 8 are located on the first body inner surface 6 of the first body 1, the first, lower rib 8 is in opposing relation to rib 8′ on second body 2, the second, upper rib 8 is positioned proximate the depression 7. When the first body 1 and second body 2 are joined by hinge 3, the depression 7, 7′ from each of the first body 1 and the second body 2 face each other and a cavity 11 is formed. The size, shape, and location of cavity 11 is configured to fit the size, shape, and location of an edge, rim, or flange of a specified product or container. The cavity 11 is preferably located near the hinge 3 to create the lowest possible profile of the mounting members 100, 101 and to allow the mounting members 100, 101 to be secured to the product or container during storage and shipment without obstructing stacking or packaging of multiple products together. Embodiments such as 100, 101 comprising one or more ribs 8, 8′, a cavity 11, or any combination thereof require increased force to remove the mounting members 100, 101 from the rim of a product or container, thereby reducing the likelihood of any mistaken or unintentional removal of the mounting member from a product or container.

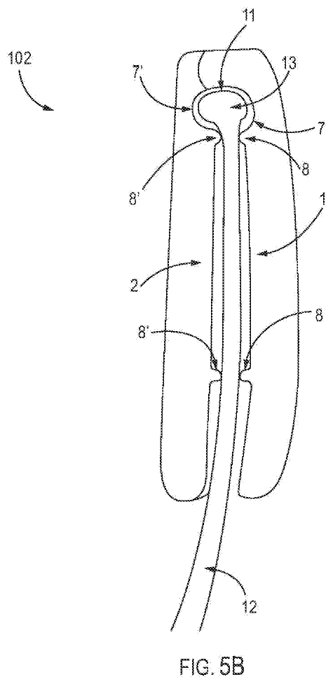

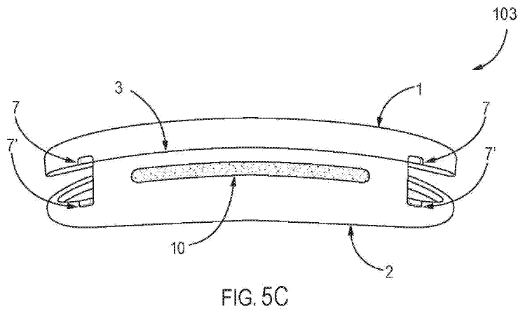

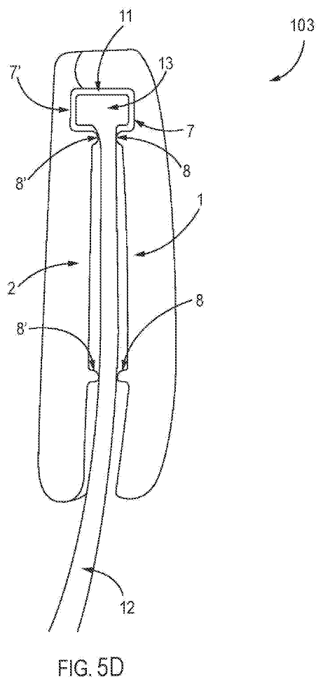

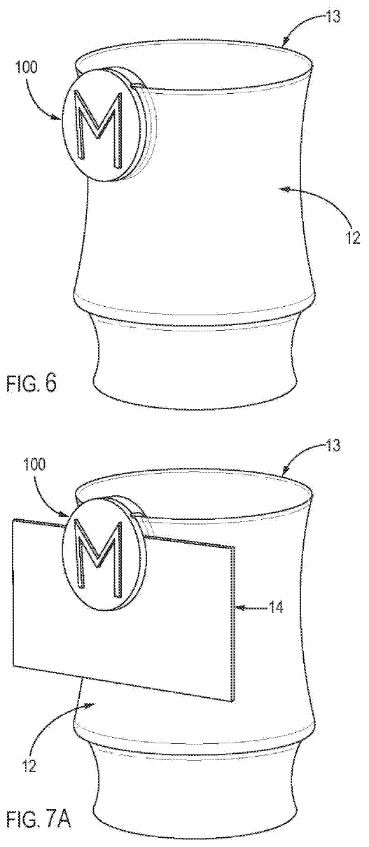

FIG. 5A is a top plan view of the mounting member 100 of FIG. 1 with depressions 7, 7′ configured to a product edge or a rim 13 of a container 12 and aperture 10 located at the hinge 3 between the first body 1 and the second body 2. The aperture 10 is configured to receive and affix additional indicia, information, and accessories for a product or container. The size, shape, depth, and location of the aperture 10 can be customized to accommodate any accessories that a user intends to add to the mounting member. FIG. 5B is a right side view of another alternate embodiment 102 of the mounting member 100 of FIG. 5A as applied to a product edge or rim 13 of container 12 having a bulbous shaped product and stabilized against container 12 by ribs 8, 8′. In this embodiment 102 an additional pair of opposing upper ribs 8, 8′ have been formed proximate depressions 7, 7′ respectively. The rim 13 is nestled into a cavity 11 formed by the depressions 7, 7′ of the first body 1 and second body 2 respectively and as seen upper ribs 8, 8′ add additional support in preventing inadvertent removal from the rim 13. FIG. 5C is a top plan view of a further alternate embodiment 103 of the mounting member 100 of FIG. 5A with depressions 7, 7′ configured to receive a square shaped product edge or rim 13 of container 12. FIG. 5D illustrates a side view of the alternate embodiment 103 of the mounting member 100 of FIG. 5C as applied to a container 12 with square shaped rim 13. The rim 13 is nestled into a cavity 11 formed by the square shaped depressions 7, 7′ of the first body 1 and second body 2. In this embodiment 103 an additional pair of opposing upper ribs 8, 8′ have been formed proximate depressions 7, 7′ for additional support in further preventing inadvertent removal.

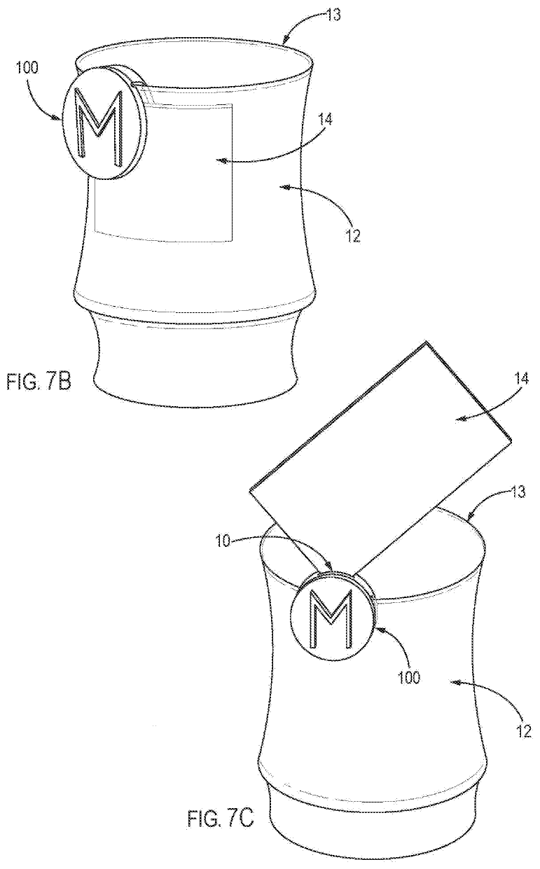

FIG. 6 is a perspective view of one embodiment of the present mounting member 100 affixed to a container 13 over rim 12 with first body 1 covering a portion of the container 13 and second body 2 covering a portion of the container 13. One or more tactile elements A on the first body 1 remain unobstructed and visible. FIG. 7A is a perspective view of an embodiment of the present disclosure in a typical environment with an accessory affixed to the mounting member 100 outside a container. 7B is a perspective view of an embodiment of the present disclosure in a typical environment with an accessory affixed to the mounting member 100 inside a container. 7C is a perspective view of an embodiment of the present disclosure in a typical environment with an accessory affixed to the mounting member 100 above a container.

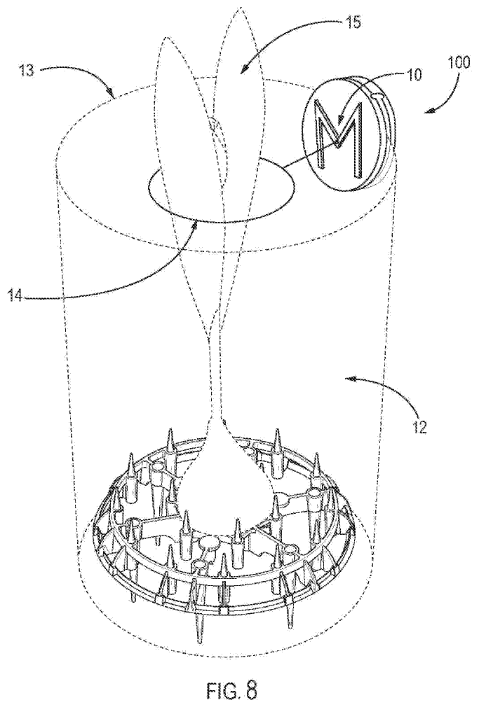

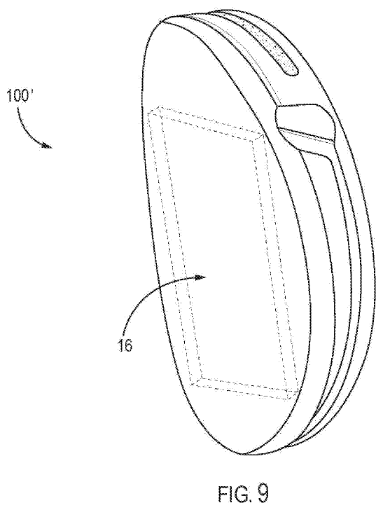

One or more accessories can be affixed to a product or container in various positions using the mounting member of the present disclosure. FIG. 8 is a perspective view of one embodiment of the present disclosure affixed to a container 13 over rim 12 with the first body 1 covering a portion of the container 13 and the second body 2 covering a portion of the container 13. One or more tactile elements A on the second body 2 remain unobstructed and visible. An accessory 14 is mounted in the aperture 10 located on the second body 2 to support product 15. Accessory 14 can be any suitable structure or device used with the mounting member 100 to enhance the function of one or all of the mounting member, product, and container.

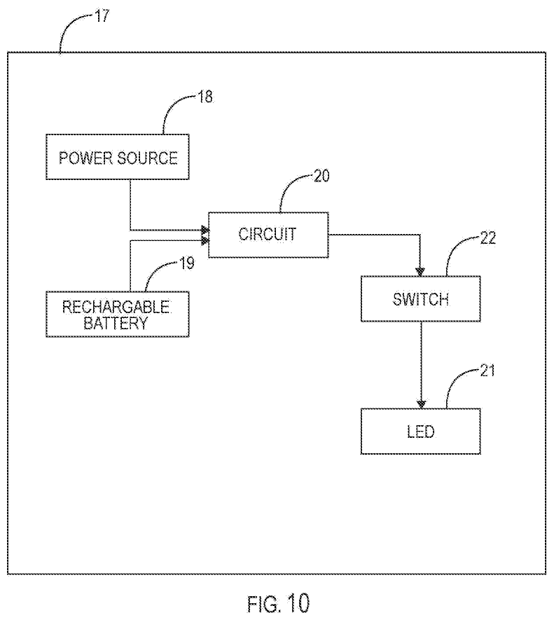

One or more embodiments of mounting members 100 may be illuminated or non-illuminated. An illuminated mounting member may be constructed from a clear, transparent, translucent material, and any combination thereof. FIG. 9 is a perspective view of still another embodiment 100′ of mounting member 100 with a compartment 16 for an illumination system. FIG. 10 is a block diagram of one embodiment of an illumination system 17 of the present disclosure wherein energy is collected from one or more external power sources 18 and directed to at least one rechargeable battery 19 by a circuit 20, which can also cause selective activation or deactivation of an LED 21 by a switch 22. In another embodiment of the illumination system of the present disclosure, the system does not include a rechargeable battery. In yet another embodiment of the illumination system of the present disclosure, the system does not include an external power source.

External power sources for an illumination system of the present disclosure can supply direct or alternating current, and components within the illumination system may further include one or more power converters. External power sources may include commercial power grids, batteries, solar cells, any other suitable power source, and any combination thereof. Components of the illumination system may be located in the first body 1, second body 2, and any combination thereof.

In the drawings and specification there has been set forth a preferred embodiment of the mounting member as disclosed herein, and although specific terms have been employed, they are used in a generic and descriptive sense only and not for purposes of limitation, the scope of the disclosure being defined in the claims. The illustrations and examples provided herein are for explanatory purposes and are not intended to limit the scope of the appended claims.

I claim:

1. A mounting member configured for releasably securing to a container defining a rim, the mounting member comprising:
a pair of oppositely disposed, spaced-apart body portions joined together at respective upper edges thereof to form a U-shaped member defining inner surfaces, the U-shaped member including portions defining an aperture;
a depression disposed on and extending across one or both of the inner surfaces, whereby a cavity is formed by at least one depression when the pair of oppositely disposed, spaced-apart body portions are joined together at the upper edges thereof;
a rib disposed on one or both of the inner surfaces below the depression, the rib extending across at least a portion of one or more of the inner surfaces, wherein the rib contacts a portion of the container when the mounting member is secured to the container;
a cavity for releasably securing the mounting device to the container rim to increase the force required to release the mounting device from the rim of a container; and
a structure for receiving one or more accessories to affix the accessories to a container, wherein the accessories can be affixed at the various stages of production, shipping, marketing, and use.

2. The mounting member of claim 1, wherein the cavity is formed to engage with the container rim.

3. The mounting member of claim 1, wherein the structure for receiving one or more accessories includes an aperture, and wherein the one or more accessories are inserted into and retained by the aperture.

4. The mounting member of claim 1, wherein the structure for receiving one or more accessories includes the rib, and wherein the one or more accessories are inserted and retained by the rib.

5. The mounting member of claim 1, wherein the U-shaped member further comprises outer surfaces including at least one tactile element to provide a gripping surface to assist securing the mounting to the container.

6. The mounting member of claim 5, wherein the at least one tactile element is configured to display information related to the container.

7. The mounting member of claim 1, wherein the U-shaped member is formed of a resilient plastic suitable for plastic injection molding.

8. The mounting member of claim 1, wherein the container is configured to hold a plant.

9. The mounting member of claim 1, wherein the U-shaped member includes a compartment for an illumination system.

10. A mounting device for affixing one or more accessories to a product edge or container rim, the mounting device comprising:
a first body portion and a second body portion, each body portion defining a top end and a bottom end, wherein each of the first and second body portion top ends are joined together such that the first body portion overlaps the second body portion;
a depression located proximal the first and second body portion top ends and extending across an inner surface of one or both of the first body portion and second body portion, wherein the depression forms a cavity between the first body portion and the second body portion when the first and second body portions are joined, and wherein the cavity is configured to engage with the product edge or container rim to increase the force required to remove the mounting device,
a rib located below the depression and extending across the inner surface of the first or second body portions, the rib defining a raised projection surface that contacts the product or container,
an aperture formed through a portion of the first body portion or second body portion for receiving one or more accessories;
wherein the mounting device is removably attached to the product edge or rim of the container holding a product to enhance the various stages of production, shipping, sale, and use of the product by allowing the one or more accessories to be affixed to the product or container.

11. The mounting device of claim 10 further comprising a tactile element located on an outer surface of the first or second body portion(s) to assist with the attachment of the mounting device to a product edge or container rim by increasing the ability to grip the mounting device while clamping the mounting device to the product edge or rim of the container holding a product.

12. The mounting device of claim 11, wherein the tactile element is configured to represent a brand logo.

13. The mounting device of claim 10, wherein the one or more accessories are inserted into the aperture and displays information relating to the product or the product within the container.

14. The mounting device of claim 10, wherein the one or more accessories are inserted into the aperture and engages the product to stabilize the product or product within the container.

15. The mounting device of claim 10, wherein the rib clamps the one or more accessories against the product or container holding a product.

16. The mounting device of claim 10, wherein the first body portion and second body portion are formed by a single piece construction.

17. The mounting device of claim 10, wherein the first body portion and second body portion are formed by a two-piece construction.

18. The mounting device of claim 17, wherein the first body portion is formed with a male adaptor and the second body portion is formed with a female adaptor configured to receive the male adaptor.

19. The mounting device of claim 10, wherein the product is a live plant.

20. The mounting device of claim 10, wherein the mounting device is formed of a plastic material suitable for plastic injection molding.
